(19) United States
(12) Patent Application Publication
(10) Pub. No.: US 2007/0241671 A1
(43) Pub. Date: Oct. 18, 2007

(54) ORGANIC ELECTRO-LUMINESCENT DISPLAY DEVICE AND MANUFACTURING METHOD THEREOF

(76) Inventors: Kazuhiko Kai, Mobara (JP); Masato Ito, Mobara (JP); Eiji Matsuzaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/733,234

(22) Filed: Apr. 10, 2007

(30) Foreign Application Priority Data
Apr. 12, 2006 (JP) 2006-109948

(51) Int. Cl. H01J 1/62; H01J 63/04

(52) U.S. Cl. 313/504

(57) ABSTRACT

The present invention enhances the light utilization efficiency of an organic EL display device. A pixel electrode PXE is formed on a protective film PAS and first banks BNKA which are constituted of a first insulation layer are formed on the pixel electrode PXE in a convex shape. On the pixel electrode PXE, in a B1 region and a B2 region defined between a pair of first banks BNKA (A1 region, A2 region), second-1 banks BNKB-1 which are constituted of a second insulation layer and are slightly raised are formed. Further, on the second-1 banks BNKB-1, second-2 banks BNKB-2 which are constituted of the second insulation layer are formed. The second-2 banks BNKB-2 have an inverted-trapezoidal shape and surfaces of the second-2 banks BNKB-2 on sides which face the first bank BNKA have an inverted taper on a substrate side. Between the pair of first banks BNKA, functional layers OLE1, OLE2, OLE5 which constitute an organic EL light emitting element are formed on the pixel electrode PXE in a C1 region, a C2 region and a C3 region, and functional layers OLE2, OLE4 are respectively formed on the second-2 banks BNKB-2 in the B1 region and the B2 region. A counter electrode COUNT is formed in a state that the counter electrode COUNT covers all of these functional layers and is formed in common with a plurality of pixels.

### CROSS-REFERENCE TO RELATED APPLICATIONS

The disclosure of Japanese Patent Application No. 2006-109948 filed on Apr. 12, 2006(yyyy/mm/dd) including the claims, the specification, the drawings and the abstract is incorporated herein by reference in its entirety.

### BACKGROUND

1. Field of the Invention

The present invention relates to an organic EL (electro-luminescent) display device and a manufacturing method thereof, and more preferably to the pixel structure which enhances the light utilization efficiency of an emitted light from an organic EL light emitting layer.

2. Description of Related Art

As a flat-panel-type display device, a liquid crystal display device (LCD), a plasma display device (PDP), a field emission type display device (FED), an organic EL display device (OLED) and the like have been put into practice or in a stage of studies for a practical use. Among these flat-panel-type display devices, as a typical example of a thin and light-weighted self-luminous display device, the organic EL display device is an extremely prominent display device as a display device in the years to come. The organic EL display device is classified into a so-called bottom emission type display device and a top emission type display device. Here, although the present invention will be explained with respect to the active-matrix-type organic EL display device, the present invention is similarly applicable to an organic EL display device such as a single-matrix-type organic EL display device with respect to the light emitting layer structure.

The present invention is particularly preferably applicable to top-emission-type active-matrix-type organic EL display device. As a conventional top-emission-type active-matrix-type organic EL display device, there has been known a display device having the structure in which each pixel includes an active element which is formed on a substrate preferably made of glass, a first insulation film which is formed on the active element, a first electrode (usually, a reflective metal electrode or an opaque electrode) which is connected with the active element via a contact hole formed in the first insulation film, a functional layer which is formed on the first electrode and includes an organic light emitting layer, a second electrode (usually, an electrode formed of a transparent conductive film made of ITO or the like) which covers the whole surface of the functional layer, and an insulation film referred to as a bank which is formed on a periphery of the first electrode and above a gap between the first electrode and the neighboring first electrode. US2004-0113550A (JP Counter-part document: JP2004-192977A, hereinafter referred to as patent document 1) describes such an organic EL display device in which the pixel includes a region where a functional layer is not formed on an upper surface of a bank which extends in the extending direction of scanning lines.

### SUMMARY

The functional layer which constitutes the light emitting structure of the organic EL display device is sandwiched between layers which differ from each other in refractive index and hence, light generated in the light emitting region is confined in the inside of the functional layer and propagates toward a non-light emitting region. According to a content disclosed in patent document 1, a region where the functional layer is not formed (pixel separation portion) is formed on an upper surface of the bank and hence, the propagation light is converted into heat energy in a path to the radiation of light in the functional-layer non-forming region or is radiated in the direction toward the substrate whereby a considerable quantity of the propagation light does not contribute to a display. If this propagation light can be taken out as a display light in a center region of the pixel, the light utilization efficiency of a quantity of light emitted from the light emitting layer is enhanced.

Accordingly, it is an object of the present invention to provide an organic EL display device which includes the pixel structure for enhancing the light utilization efficiency and a manufacturing method of the organic EL display device.

The organic EL display device of the present invention is configured such that a plurality of pixels are formed on one surface of a substrate, each pixel includes an organic EL element which is provided with an organic light emitting layer between a first electrode and a second electrode, an active element which controls an electric current flowing into the organic EL element, and a first insulation layer which is formed between the organic EL element and the active element.

Further, to achieve the above-mentioned object, according to the present invention, the first electrode is formed for every pixel in a separating manner, the second electrode is formed in common with a plurality of pixels, and a periphery of the first electrode is covered with the first insulation layer. On the first electrode excluding a periphery thereof, a second insulation layer which is formed on the same layer as the first insulation layer is formed, a stepped portion is formed on the second insulation film with respect to the surface of the substrate, and the second electrode and the organic light emitting layer is separated by the stepped portion from each other in the inside of each pixel.

Further, in the present invention, an angle of the second insulation layer which forms the stepped portion remote from the substrate may be made of an acute angle, and the stepped portion may be formed of a surface with a normal taper with respect to the surface of the substrate and a surface with an inverted taper with respect to the surface of the substrate.

Further, in the present invention, the second insulation layer may form a surface with a normal taper with respect to the surface of the substrate in a region sandwiched between the first insulation layer and the second insulation layer, and peripheries of the second electrode and the organic light emitting layer may be arranged on the surface with the normal taper.

Further, in the present invention, a surface with an inverted taper may be formed on a lower layer of a surface with the normal taper, and on a region except for the periphery of the first electrode, the second insulation layer having a surface with an inverted taper with respect to the first electrode may be formed, and peripheries of the second electrode and the organic light emitting layer may be formed on the surface with the inverted taper.

Further, in the present invention, a surface with an inverted taper may be formed in a region sandwiched by the first insulation layer and the second insulation layer on the second insulation layer, and peripheries of the second electrode and the organic light emitting layer may be arranged on the surface with the inverted taper.

A manufacturing method of an organic EL display device according to the present invention includes the steps of forming first electrodes in a state that each first electrode is formed for every pixel in a separating manner, forming an insulation layer between the first electrode and the neighboring first electrode, and on a periphery of the first electrode, and a portion of the center of the first electrode after forming the first electrodes, and forming an organic light emitting material and the second electrodes in this order on the insulation layer after forming the insulation layer.

By separating the light emitting region in the inside of the pixel, light which propagates in a non-light emitting portion in the direction parallel to the surface of the substrate can be also used as a display light thus enhancing the utilization efficiency of the light thus enabling the acquisition of a display of high brightness.

### BRIEF DESCRIPTION OF THE DRAWINGS

FIG. 1 is a view for explaining one example of the circuit constitution of an organic EL display device;

FIG. 2 is a view for explaining the constitution of a cross section in the vicinity of one pixel of a top emission type organic EL display device according to the present invention;

FIG. 3 is a schematic cross-sectional view in the vicinity of one pixel for explaining an embodiment 1 of the organic EL display device according to the present invention;

FIG. 4 is a schematic cross-sectional view of a part A in FIG. 3 for explaining an embodiment 2 of the organic EL display device of the present invention;

FIG. 5A is a view for explaining a manufacturing method of the organic EL display device of the present invention;

FIG. 5B is a view succeeding FIG. 5A for explaining the manufacturing method of the organic EL display device of the present invention;

FIG. 5C is a view succeeding FIG. 5B for explaining the manufacturing method of the organic EL display device of the present invention;

FIG. 5D is a view succeeding FIG. 5C for explaining the manufacturing method of the organic EL display device of the present invention;

FIG. 5E is a view succeeding FIG. 5D for explaining the manufacturing method of the organic EL display device of the present invention;

FIG. 5F is a view succeeding FIG. 5E for explaining the manufacturing method of the organic EL display device of the present invention;

FIG. 5G is a view succeeding FIG. 5F for explaining the manufacturing method of the organic EL display device of the present invention;

FIG. 5H is a view succeeding FIG. 5G for explaining the manufacturing method of the organic EL display device of the present invention;

FIG. 5I is a view succeeding FIG. 5H for explaining the manufacturing method of the organic EL display device of the present invention;

FIG. 5J is a view succeeding FIG. 5I for explaining the manufacturing method of the organic EL display device of the present invention;

FIG. 6 is a schematic plan view of one pixel for explaining a first shape of a light takeout bank in the present invention;

FIG. 7 is a schematic plan view of one pixel for explaining a second shape of the light takeout bank in the present invention;

FIG. 8 is a schematic plan view of one pixel for explaining various shapes of the light takeout bank in the present invention; and

FIG. 9 is a schematic view showing various cross-sectional shapes of a bank taken along a line Z1-Z2 shown in FIG. 6 or in FIG. 7.

### DETAILED DESCRIPTION OF THE INVENTION

Hereinafter, embodiments of the present invention are explained in detail in conjunction with drawings showing the embodiments. First of all, a circuit constitutional example of an organic EL display device and the structure of a top-emission-type organic EL display device are explained.

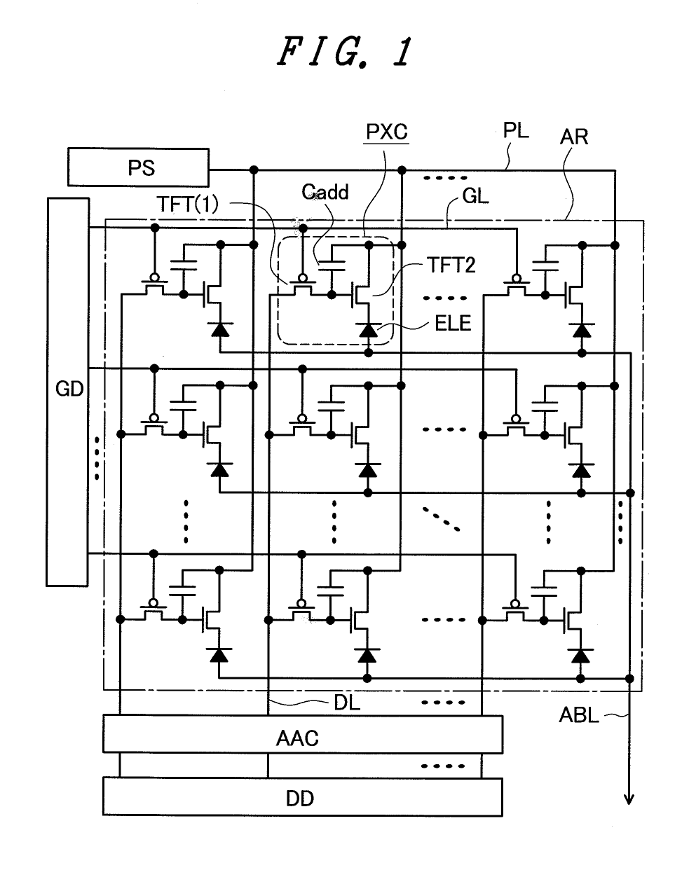

FIG. 1 is a view for explaining one example of the circuit constitution of the organic EL display device. A plurality of pixel circuits PXC are arranged on a substrate in a matrix array thus constituting a display area AR. The pixel circuit PXC is constituted of an organic EL element ELE, a switching thin film transistor TFT1 (for example, p-MOS), a data holding capacitance Cadd, a driving thin film transistor TFT2 (for example, n-MOS) for driving the organic EL element ELE.

A gate of the thin film transistor TFT1 is connected with a scanning drive circuit (gate driver) GD through a scanning line GL and is selected at timing of horizontal scanning, and a data signal from a signal line DL is stored in the data holding capacitance Cadd. The thin film transistor TFT2 becomes conductive at display timing and an electric current corresponding to a magnitude of the data signal stored in the data holding capacitance Cadd flows into an anode from a power source line PL via a cathode of the organic EL element ELE. A predetermined current is supplied to the power source line PL from a power source PS. Here, the signal lines DL are connected to a signal line drive circuit (data driver) DD via an analogue adder AAC. The anode of the organic EL element ELE is connected with an anode bus line ABL.

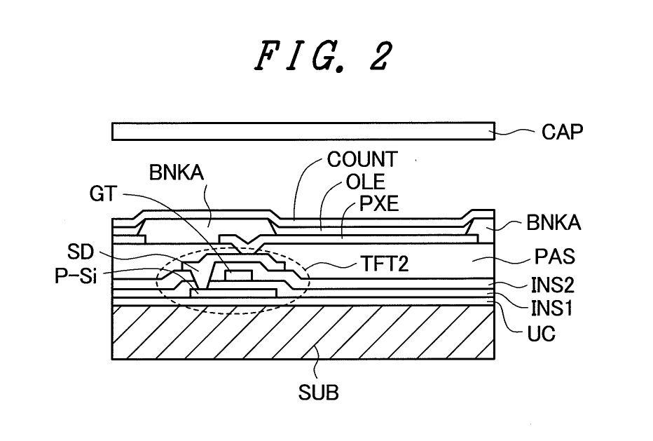

FIG. 2 is a view for explaining the cross-sectional constitution of the vicinity of one pixel of the top-emission-type organic EL display device. The substrate SUB is preferably made of quartz glass or alkali-free glass. A background film UC is formed on one surface (main surface) of the substrate SUB. The background film UC is a stacked film of SiN/SiO which is formed by a plasma CVD process. On the background film UC, a poly-silicon film P-Si is formed by crystallizing an amorphous silicon a-Si film which is formed by a CVD using an excimer laser, and a poly-silicon film p-Si having the LDD structure is formed in an island shape by a wet process. The thin film transistor which is constituted of the poly-silicon film p-Si corresponds to the driving thin film transistor TFT2 shown in FIG. 1.

A gate insulation film INS1 is formed in a state that the gate insulation film INS1 covers the poly-silicon film P-Si. The gate insulation film INS1 is made of TEOS and is formed by a CVD process. A gate electrode GT is formed on the gate insulation film INS1 above the poly-silicon film P-Si. The gate electrode GT is a metal electrode (made of MoW) and is formed as a film by a sputter process and, thereafter, is processed by a wet process. An interlayer insulation film INS2 is formed on the gate electrode GT. The interlayer insulation film INS2 is made of SiO and is formed by a CVD process.

A contact hole is formed through the gate insulation film INS1 and the interlayer insulation film INS2, and a source/drain electrode SD is formed as a film on the interlayer insulation film INS2. The source/drain electrode SD is connected with the poly-silicon film P-Si via the contact hole. The source/drain electrode SD has the stacked structure formed of MoW/Al—Si/MoW. The source/drain electrode SD is formed as a film by sputter process and, thereafter, is processed by a dry or wet process.

A protective film (passivation film) PAS is formed in a state that the protective film PAS covers the source/drain electrode SD. A pixel electrode (a lower electrode, a cathode in this embodiment) PXE is formed as a film on the protective film PAS, and the pixel electrode PXE is connected with the source/drain electrode SD via a contact hole formed in the protective film PAS. The pixel electrode PXE is formed of a metal electrode and is made of aluminum Al in this embodiment. The pixel electrode PXE is also formed as a film by a sputterprocess and, thereafter, is processed by a wet process.

A bank portion (bank) BNKA made of SiN is formed above the thin film transistor. The bank BNKA is a pixel partitioning bank which is provided for partitioning the neighboring pixels. In a recessed portion formed between the neighboring pixel partitioning bank BNKA, a functional layer OLE which constitutes an organic EL element on the pixel electrode PXE is formed by a vapor deposition method or the like. The functional layer OLE is formed by stacking an electron injection layer, an electron transport layer, a light emitting layer, a hole transport layer, a hole injection layer and a vanadium pentoxide layer in this order from the pixel electrode PXE side.

Further, a counter electrode (an upper electrode) COUNT is formed in a state that the counter electrode COUNT covers the functional layer OLE and the pixel partitioning bank BNKA. The counter electrode COUNT is formed of a transparent electrode and is made of IZO in this embodiment. However, the counter electrode COUNT may be made of ITO or is formed of other transparent conductive film. The counter electrode COUNT is formed by a sputtering method in a state that the counter electrode COUNT covers a plurality of pixels in common. Here, the counter electrode COUNT functions as an anode.

A main surface of the substrate SUB having such constitution is sealed by a sealing substrate CAP. In this constitutional example, the sealing substrate CAP is made of a material substantially equal to a material of the substrate SUB and is configured such that a periphery thereof is formed in a convex shape and a center portion thereof is formed in a recessed shape. Further, a sealing agent is applied to the convex-shaped portion on the periphery of the sealing substrate CAP and the sealing agent is cured by radiating ultraviolet rays to the sealing agent in an inert atmosphere and hence, the sealing substrate CAP is hermetically fixed to the substrate SUB thus defining a sealed space between the substrate SUB and the sealing substrate CAP. A moisture-proof material or a desiccant may be accommodated in the sealed space.

### EMBODIMENT 1

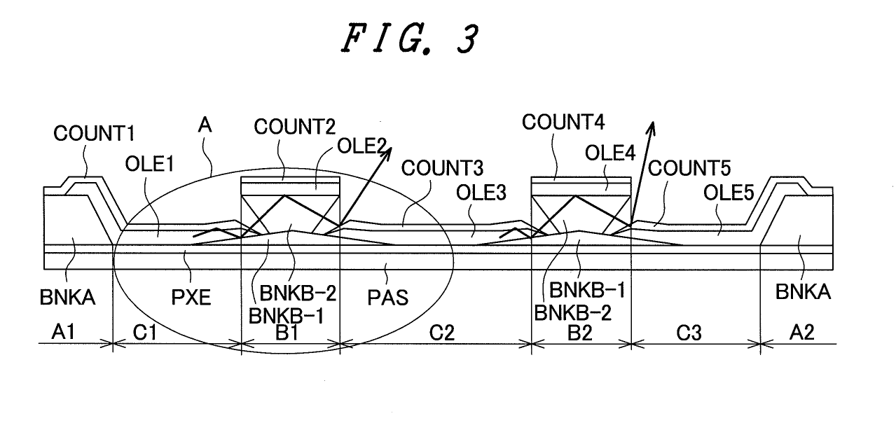

FIG. 3 is a schematic cross-sectional view in the vicinity of one pixel for explaining an embodiment 1 of the organic EL display device according to the present invention. FIG. 3 shows the structure which is formed above the protective film PAS formed on the main surface of the substrate SUB shown in FIG. 2. In the drawing, the circuit structure of the thin film transistor or the like is omitted. In FIG. 3, the pixel electrode PXE is formed on the protective film PAS, and first banks BNKA are formed of a first insulation layer in a projecting manner. A recessed portion formed between a pair of first banks BNKA defines one pixel region. In this embodiment 1, this pixel region is divided into a C1 region, a B1 region, a C2 region, a B2 region, and a C3 region. Here, regions of the pair of first banks BNKA are respectively indicated by an A1 region and an A2 region.

On the pixel electrode PXE in the B1 region and the B2 region, a second-1 bank BNKB-1 constituted of a second insulation layer is formed in a slightly raised manner. Further, on the second-1 bank BNKB-1, a second-2 bank BNKB-2 constituted of a second insulation layer is formed. An upper surface of the second-2 bank BNKB-2 constituted of the second insulation layer is substantially as high as an upper surface of the first bank BNKA. Further, the second-2 bank BNKB-2 has an inverted trapezoidal cross-sectional shape, wherein a surface of a side of the second-2 bank BNKB 2 which faces the first bank BNKA in an opposed manner has an inverted taper on the substrate side.

Between the pair of first banks BNKA, functional layers OLE1, OLE3, OLE5 which constitute organic EL light emitting elements are formed on the pixel electrode PXE in the C1 region, the C2 region and the C3 region among the C1 region, the B1 region, the C2 region, the B2 region, and the C3 region, while functional layers OLE2 and OLE4 are respectively formed on the second-2 bank BNKB-2 in the B1 region and the B2 region. Here, in the A1 region, the B1 region, the B2 region and the A2 region, the functional layers in the neighboring regions are formed in a state that the functional layers slightly exceed boundaries. Further, a counter electrode COUNT is formed in a state that the counter electrode COUNT covers all these functional layers in common with respect to a plurality of pixels. In FIG. 3, the counter electrode COUNT is indicated in a separated manner such that a counter electrode COUNT1 is arranged in the A1 region and the C1 region, a counter electrode COUNT2 is arranged in the B1 region, a counter electrode COUNT3 is arranged in the C2 region, a counter electrode COUNT4 is arranged in the B2 region, and a counter electrode COUNT5 is arranged in the C3 region and the A2 region. It is needless to say that these counter electrodes are electrically connected with each other at portions not shown in the drawing.

In this manner, in the pixel structure in which the light emitting region is separated within the pixel, when a portion of light emitted from the functional layer OLE1 propagates substantially along a surface of the substrate, as indicated by a bold arrow in FIG. 3, the light is reflected on interfaces or inclined surfaces between the counter electrode and the second-1 bank BNKB-1, and between the second-2 bank BNKB-2 and the functional layer or the like and is, eventually, radiated as a display light.

In this manner, according to the embodiment 1, by separating the light emitting region within the pixel, the light which propagates toward the non-light emitting portion such as the bank in the direction along the surface of the substrate can be used as the display light thus enhancing the light utilization efficiency whereby a display of high brightness can be acquired.

### EMBODIMENT 2

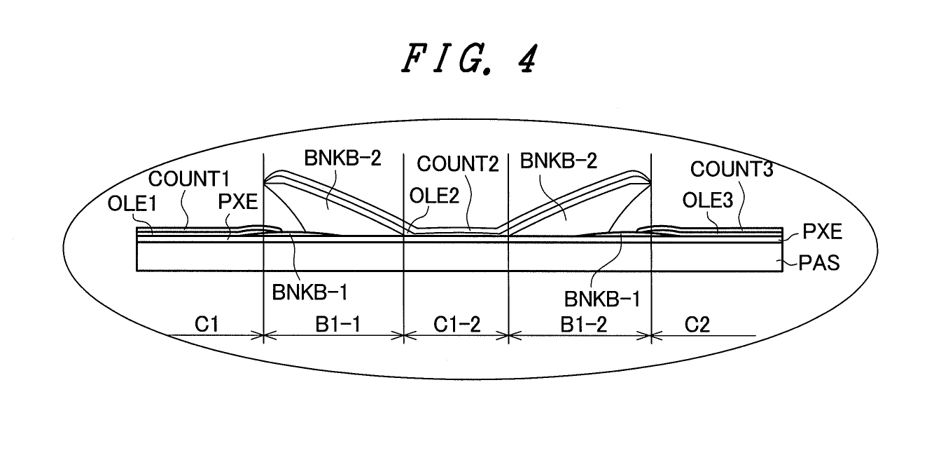

FIG. 4 is a schematic cross-sectional view of a part A in FIG. 3 for explaining an embodiment 2 of an organic EL display device of the present invention. In the embodiment 2, the B1 region which is defined between the C1 region and the C2 region in FIG. 3 is divided into a B1-1 region, a C1-2 region and a B1-2 region, and second banks BNKB-2 which are arranged like a wing and respectively have an approximately trapezoidal shape in cross section as shown in FIG. 4 are formed in the B1-1 region and the B1-2 region. A functional layer OLE2 and a counter electrode COUNT2 are formed over these second-2 bank BNKB-2 and the C1-2 region.

Also in the second embodiment 2, by separating the light emitting region within the pixel, the light which propagates toward the non-light emitting portion such as the bank in the direction along the surface of the substrate can be used as the display light thus enhancing the light utilization efficiency whereby a display of high brightness can be acquired.

### EMBODIMENT 3

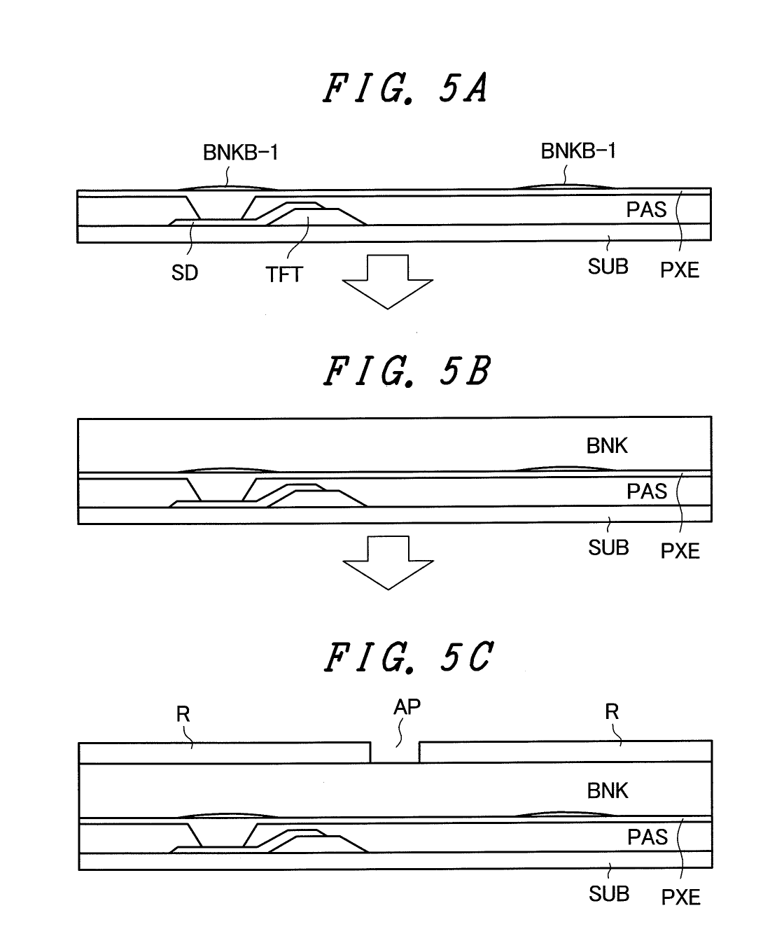

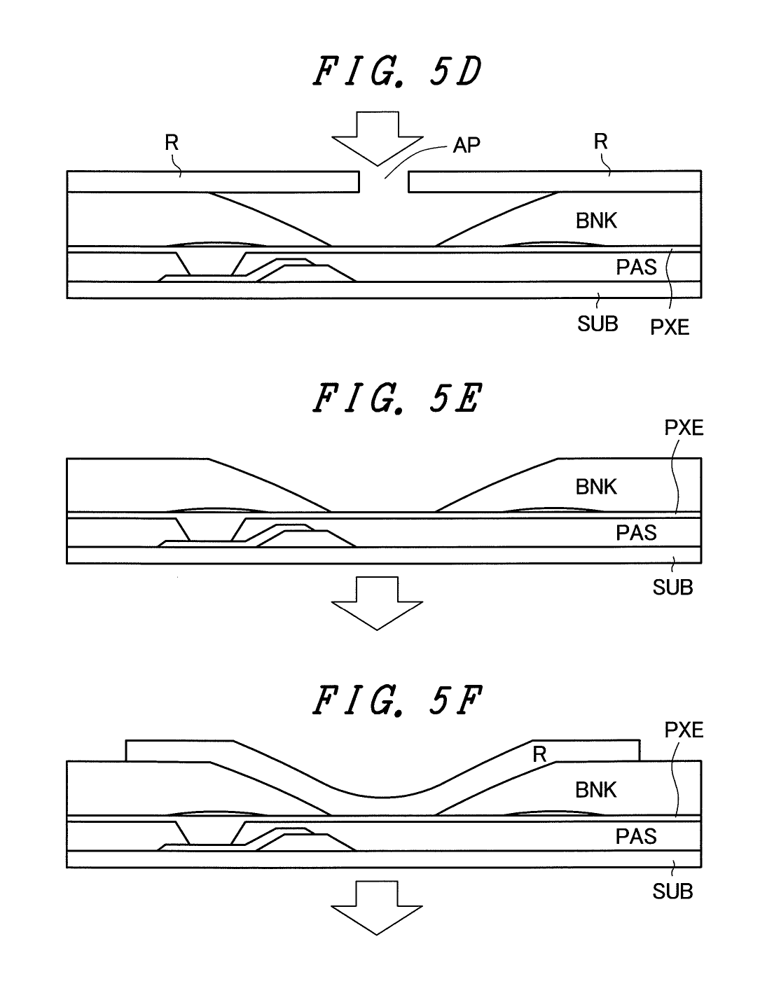

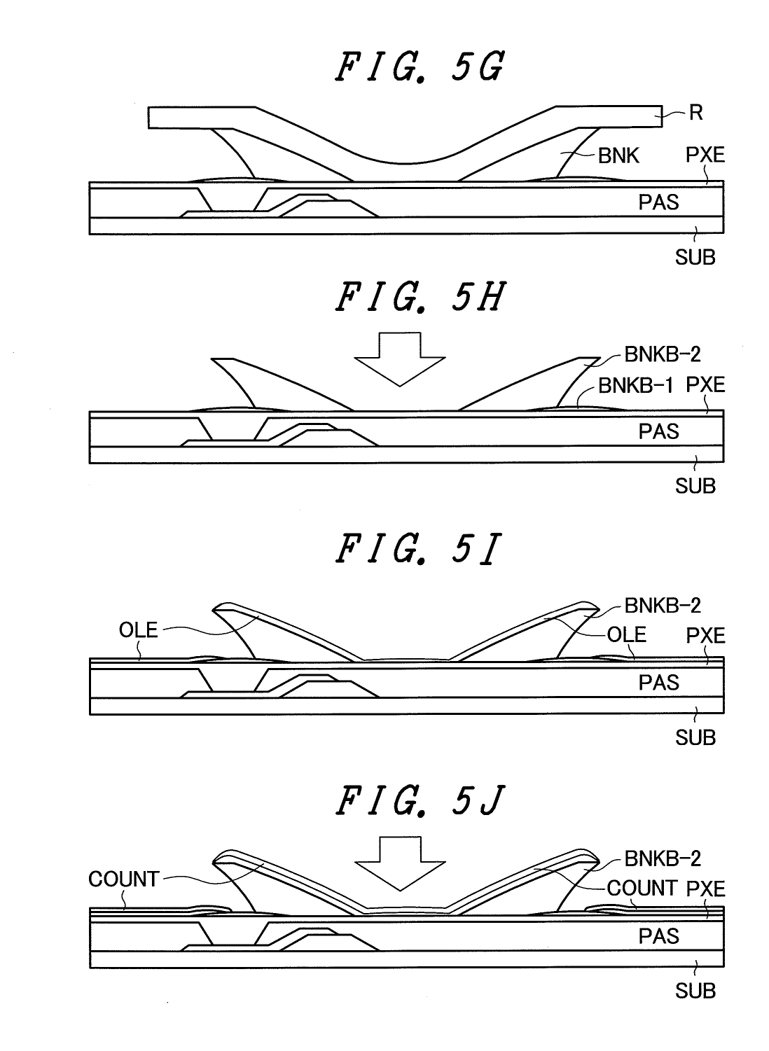

Next, a manufacturing method of the organic EL display device according to the present invention is explained as an embodiment 3 in conjunction with FIG. 5A to FIG. 5J. Here, the explanation is made with respect to the manufacture of the organic EL display device explained in conjunction with FIG. 4 as an example. First of all, on the pixel electrode PXE of the substrate SUB on which the thin film transistor TFT, the source/drain SD, the protective film PAS and the pixel electrode PXE inclusive are formed, the second-1 bank BNKB-1 is formed (FIG. 5A). The second-1 bank BNKB-1 made of SiN is formed as a film by a PCVD(plasma CVD) and, thereafter, is formed into a pattern by a wet process.

A silicon nitride SiN is formed as a film which covers the second-1 bank BNKB-1 thus forming a bank layer BNK which constitutes the second-2 bank (FIG. 5B). The bank layer BNK is formed as a film by a PCVD (plasma CVD). Here, the oxygen concentration of a lower layer is increased to form a silicon nitride SiN having a fixed Si/N ratio.

A photosensitive resist R is applied to the bank layer BNK, and an aperture AP is formed between the second-1 banks BNKB-1 by a photolithography process (FIG. 5C). Dry etching is applied to the bank layer BNK through the aperture AP (FIG. 5D). Here, an approximately inverted trapezoidal removed portion is formed using the aperture AP as the center thereof by over etching. Thereafter, the photosensitive resist R is removed by peeling (FIG. 5E).

Next, a photosensitive resist R is applied thus leaving the photosensitive resist R in the approximately inverted trapezoidal removed portion and the second-2 bank forming region by photolithography process (FIG. 5F). Wet etching is applied by way of the photosensitive resist R. Here, side portions of the photosensitive resist R are over-etched (FIG. 5G). Thereafter, the photosensitive resist R is removed by peeling thus acquiring the second-2 banks BNKB-2 which are arranged like a wing and have an approximately trapezoidal shape (FIG. 5G) (FIG. 5H).

The functional layer OLE which constitutes the organic EL light emitting layer is formed on the pixel electrode PXE, the second-1 bank BNKB-1, and the second-2 bank BNKB-2 by a vapor deposition method (FIG. 5I). Further, the counter electrode COUNT is formed as a film (FIG. 5J) . The functional film OLE and portions of the counter electrode COUNT are also formed at portions which are concealed by wing-like overhanging second-2 banks BNKB-2. Due to such a constitution, the pixel structure shown in FIG. 4 is acquired.

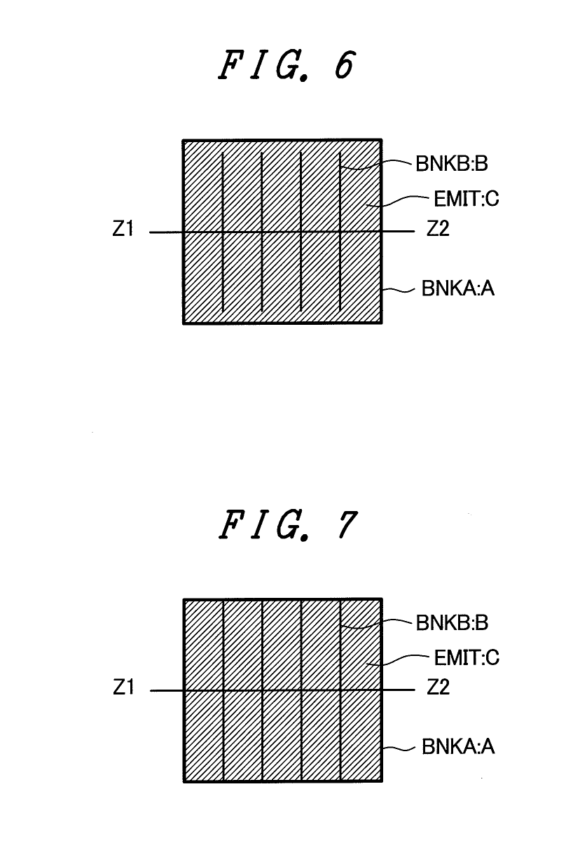

FIG. 6 is a schematic plan view of one pixel for explaining a first shape of a light takeout bank in the present invention. An outer frame in FIG. 6 indicates the first bank BNKA (a region A (A-1 region, A-2 region)) in FIG. 3, vertical fine lines indicate second-2 banks BNKB (second-1 bank BNKB-1, second-2 bank BNKB-2), and a hatched portion indicates a light emitting area (light emitting region, C region) . In this example, four second banks BNKB are provided and end portions of the second banks are separated from the first bank BNKA.

FIG. 7 is a schematic plan view of one pixel for explaining a second shape of the light takeout bank according to the present invention. The numbers of the first banks BNKA, the second banks BNKB, the light emitting areas and the second banks BNKB in FIG. 7 are equal to the numbers of the corresponding parts in FIG. 6. A point which makes the constitution shown in FIG. 7 differ from the constitution shown in FIG. 6 lies in that the end portions of the second banks BNKB are abutted to the first banks BNKA.

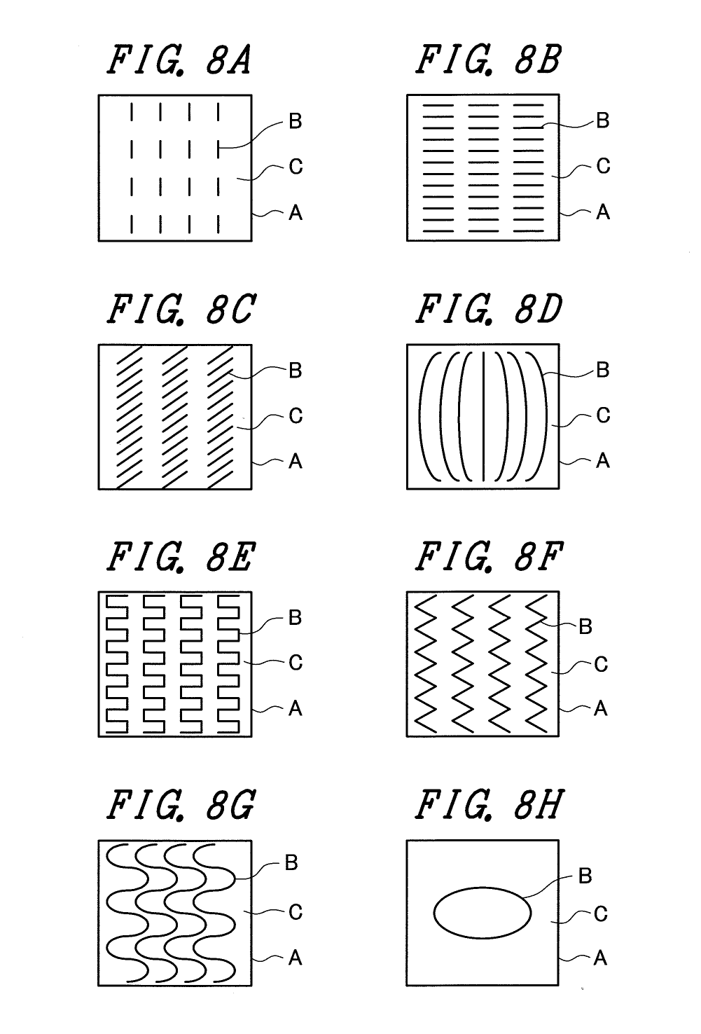

FIG. 8 is a schematic plan view of one pixel for explaining other various shapes of the light takeout bank according to the present invention. In FIG. 8(a) to FIG. 8(h), an outer frame and fine lines respectively show functional parts identical to the functional parts shown in FIG. 6 and FIG. 7. A white matted portion in the inside of the outer frame is a light emitting region (light emitting area) . Out of the pixel structures shown in FIG. 8(a) to FIG. 8(h), a second bank BNKB shown in FIG. 8(h), is connected in a circular shape and hence, the electrical conductivity is interrupted whereby light is not emitted from the inside of the circle thus providing a pixel pattern in which a circular non-light emitting pattern is surrounded by a rectangular light emitting pattern.

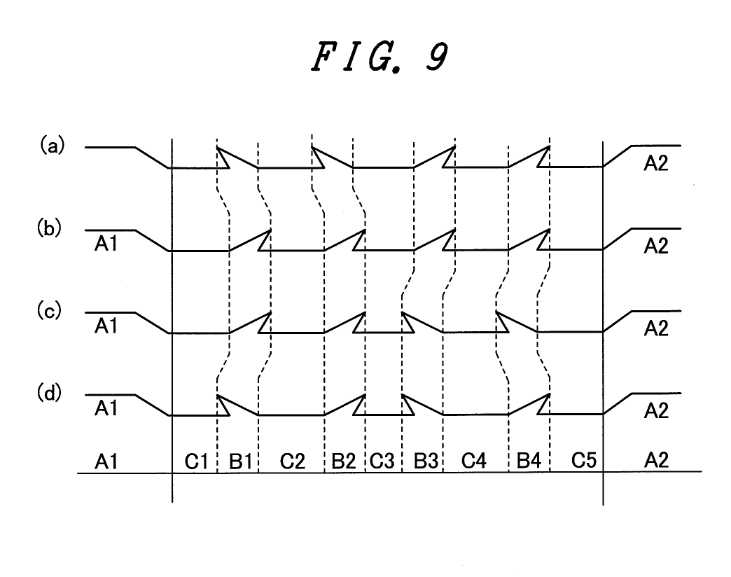

FIG. 9 is a schematic view showing various cross-sectional shapes of the bank taken along a line Z1-Z2 shown in FIG. 6 or in FIG. 7. Symbols A1, A2 indicate first banks which define one pixel, while symbols B1 to B4 indicate second banks (light takeout banks) and symbols C1 to C5 indicate light emitting regions. Here, although the number of second banks is set as 4, the present invention is not limited to such an example.

1. An organic EL display device comprising:
a substrate; and
a plurality of pixels formed on one surface of the substrate, each pixel including an organic EL element which is provided with an organic light emitting layer between a first electrode and a second electrode, an active element which controls an electric current flowing into the organic EL element, and a first insulation film which is formed between the organic EL element and the active element, wherein
the first electrode is formed for every pixel in a separating manner,
the second electrode is formed in common with a plurality of pixels,
a periphery of the first electrode is covered with the first insulation layer,
a second insulation layer which is formed on the same layer as the first insulation layer is formed on the first electrode excluding a periphery thereof,
a stepped portion is formed on the second insulation film with respect to a surface of the substrate, and
the second electrode and the organic light emitting layer is separated from each other by the stepped portion in the inside of each pixel.

2. An organic EL display device according to claim 1, wherein an angle of the second insulation layer which forms the stepped portion remote from the substrate is made of an acute angle.

3. An organic EL display device according to claim 2, wherein the stepped portion is formed of a surface with a normal taper with respect to the surface of the substrate and a surface with an inverted taper with respect to the surface of the substrate.

4. An organic EL display device comprising:
a substrate;
a plurality of pixels formed on one surface of a substrate, each pixel including an organic EL element which is provided with an organic light emitting layer between a first electrode and a second electrode, an active element which controls an electric current flowing into the organic EL element, and a first insulation layer which is formed between the organic EL element and the active element, wherein
the first electrode is formed for every pixel unit in a separating manner,
the second electrode is formed in common with a plurality of pixels,
a periphery of the first electrode is covered with the first insulation layer,
a second insulation layer which is formed on the same layer as the first insulation layer is formed on the first electrode excluding a periphery thereof,
the second insulation layer forms a surface with a normal taper with respect to the surface of the substrate in a region sandwiched between the first insulation layer and the second insulation layer, and
peripheries of the second electrode and the organic light emitting layer are arranged above the surface with the normal taper.

5. An organic EL display device according to claim 4, wherein a surface with an inverted taper is formed below a surface with the normal taper.

6. An organic EL display device according to claim 4, wherein a second insulation layer having a surface with an inverted taper with respect to a surface of the first electrode is formed on a region of the first electrode except for a periphery of the first electrode, and
peripheries of the second electrode and the organic light emitting layer are arranged on the surface with the inverted taper.

7. An organic EL display device comprising:
a substrate;
a plurality of pixels formed on one surface of a substrate, each pixel including an organic EL element which is provided with an organic light emitting layer between a first electrode and a second electrode, an active element which controls an electric current flowing into the organic EL element, and a first insulation layer which is formed between the organic EL element and the active element, wherein
the first electrode is formed for every pixel unit in a separating manner,
the second electrode is formed in common with a plurality of pixels,
a periphery of the first electrode is covered with the first insulation layer,
a second insulation layer which is formed on the same layer as the first insulation layer is formed on the first electrode excluding a periphery thereof,
the second insulation layer forms a surface with an inverted taper in a region sandwiched between the first insulation layer and the second insulation layer, and
peripheries of the second electrode and the organic light emitting layer are arranged above the surface with the inverted taper.

8. A manufacturing method of an organic EL display device comprising the steps of:
forming first electrodes in a state that each first electrode is formed for every pixel in a separating manner;
forming an insulation layer between the first electrode and the neighboring first electrode, and on a periphery of the first electrode, and a portion of the center of the first electrode after forming the first electrodes; and
forming an organic light emitting material and the second electrodes in this order on the insulation layer after forming the insulation layer.
